(19) United States
(12) Patent Application Publication
(10) Pub. No.: US 2012/0205058 A1
(43) Pub. Date: Aug. 16, 2012

(54) SEMI-AUTOMATIC SUNSHADE DEVICE

(75) Inventor: Paul LIN, Tainan City (TW)

(73) Assignee: Macauto Industrial Co., Ltd., Tainan City (TW)

(21) Appl. No.: 13/356,017

(22) Filed: Jan. 23, 2012

(30) Foreign Application Priority Data
Feb. 16, 2011 (TW) 100105092

(51) Int. Cl. B60J 3/02

(52) U.S. Cl. 160/370.22

(57) ABSTRACT

A semi-automatic sunshade device includes a housing receiving a winding shaft to hold a shading cloth. An upstanding guide rod for operating the shading cloth is inserted into a guide rod case disposed beneath the housing. A buffer support is disposed between the housing and the guide rod case to hold a hollow moving body. The guide rod extends through the hollow moving body and is clamped movably by buffer members that are disposed inside the moving body in rolling contact with the guide rod. The buffer members hinder movements of the guide rod and are able to prevent impact forces when the shading cloth is stretched or un-stretched.

### CROSS-REFERENCE TO RELATED APPLICATION

This application claims priority of Taiwanese Patent Application No. 100105092 filed on Feb. 16, 2011.

### BACKGROUND OF THE INVENTION

1. Field of the Invention

The invention relates to a semi-automatic sunshade device, and more particularly to a collapsible and expandable sunshade device that may be mounted on a side window of a vehicle.

2. Description of the Related Art

Referring to FIG. 1, a conventional semi-automatic sunshade device 1 for a side window of a vehicle basically includes a housing 1 holding a shading cloth 13 wound around a winding shaft 12. To retain the shading cloth 13 in an expanded state, an end strip 14 is attached to one end of the shading cloth 13 opposite to the winding shaft 12 and is provided with a hanging lug 15 on the end strip 14 to be hooked on a hook 16. In use, the end strip 14 is pulled to move the shading cloth 13 out of the housing 11, and the hanging lug 15 is hung on the hook 16, thereby placing the shading cloth 13 in an extended position. When the hanging lug 15 is detached from the hook 16 to release the shading cloth 13, the shading cloth 13 is moved downward and wound by the winding shaft 12 at a fast speed.

The operation of the sunshade device 1 is inconvenient because the hanging lug 15 has to be hooked on the hook 16 to maintain the shading cloth 13 at its expanded state. Furthermore, if the hook 16 is not aligned with the hanging lug 15 because of positional deviation in assembly of component parts, the shading cloth 12 cannot present a neat and evenly flat appearance in its expanded state. For convenient operation, improvements have been provided to automatically expand and move upward the shading cloth of the sunshade device. However, disadvantages still exist because rewinding of the shading cloth is fast and is liable to cause mutual collision between the component parts of the sunshade device. For instance, the end strip of the shading cloth can impact the housing of the winding shaft producing noises and vibrations when moving downward by the rewinding action of the winding shaft. Further improvements are desirable to address the problem of undesirable impacts and vibration.

### SUMMARY OF THE INVENTION

A main object of the present invention is to provide a semi-automatic sunshade device that can mildly and gently stretch and un-stretch a shading cloth to eliminate noises and vibrations.

Accordingly, a semi-automatic sunshade device of the present invention comprises a housing, a winding shaft, a shading cloth, an end strip, a guide and a buffer. The housing has a top side formed with a passageway. The winding shaft is mounted rotatably inside the housing. The shading cloth is wound around the winding shaft. The end strip is attached to one end of the shading cloth opposite to the winding shaft and disposed outwardly of the passageway. The guide extends in a top-bottom direction beneath the housing, and includes a guide rod case that has a top end proximate to a bottom side of the housing, and a guide rod inserted slidably into the guide rod case and having a top end connected to the end strip. The buffer includes a buffer support disposed fixedly between the housing and the guide rod case, a hollow moving body disposed movably in the buffer support and around the guide rod, and a plurality of buffer members clamping movably the guide rod and disposed inside the hollow moving body in rolling contact with the guide rod. The buffer members hinder ascending or descending movements of the guide rod when the shading cloth is stretched or un-stretched.

### BRIEF DESCRIPTION OF THE DRAWINGS

Other features and advantages of the present invention will become apparent in the following detailed description of the preferred embodiments with reference to the accompanying drawings, of which:

FIG. 1 is a conventional semi-automatic sunshade device in the prior art;

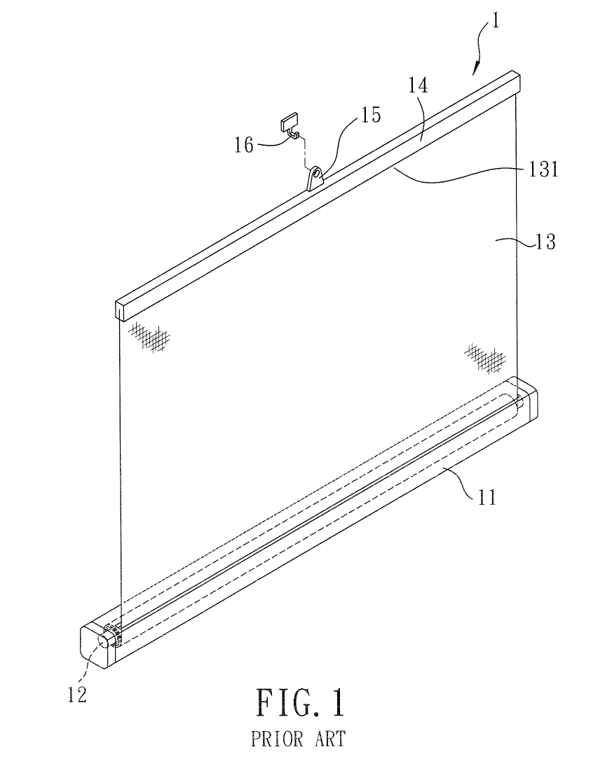

FIG. 2 is a partly sectioned view illustrating a semi-automatic sunshade device according to the first preferred embodiment of the present invention in a stretched state;

FIG. 3 is a partly enlarged view of FIG. 2;

FIG. 4 is a fragmentary exploded perspective view of a buffer employed in the first preferred embodiment;

FIG. 5 is a partly sectioned view illustrating the first preferred embodiment in an un-stretched state;

FIG. 6 is the same view as FIG. 3 but showing the guide rod in an inclined state; and

FIG. 7 is a partly sectioned view illustrating the second preferred embodiment of a semi-automatic sunshade device according to the present invention.

### DETAILED DESCRIPTION OF THE PREFERRED EMBODIMENTS

Before the present invention is described in greater detail with reference to the accompanying preferred embodiment, it should be noted herein that like elements are denoted by the same reference numerals throughout the disclosure.

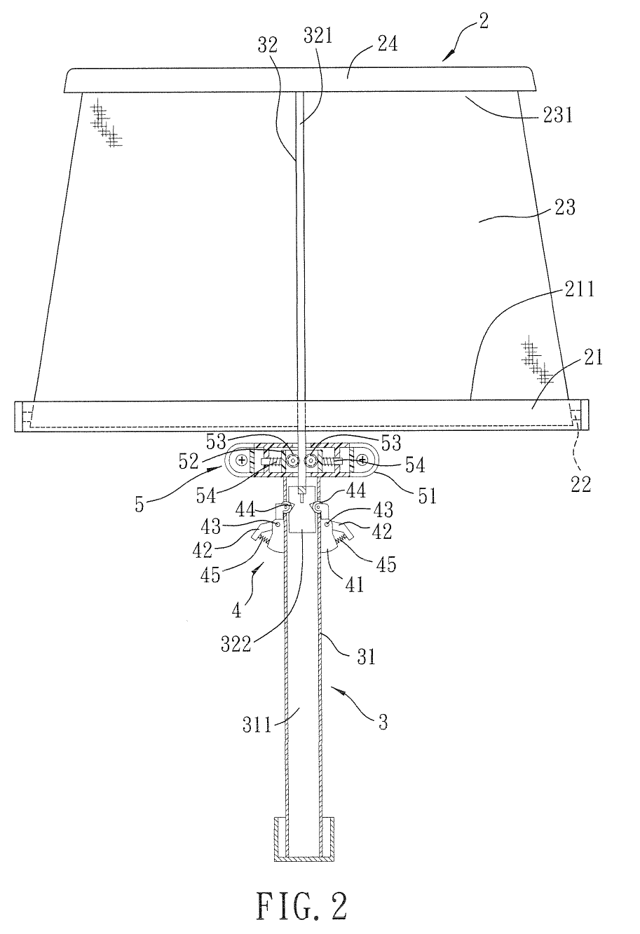

Referring to FIGS. 2 to 5, there is shown a semi-automatic sunshade device according to the first preferred embodiment of the present invention, which is mountable on a door of a vehicle to shade a side window of the door. The semi-automatic sunshade device includes a shading unit 2, a guide 3, a positioning unit and a buffer 5.

The shading unit 2 includes a housing 21, a spring-loaded winding shaft 22, a shading cloth 23, and an end strip 24.

The housing 21 has a top side formed with a passageway 211. The spring-loaded winding shaft 22 is mounted rotatably inside the housing 21. The shading cloth 23 is wound around the winding shaft 22. The end strip 24 is attached to one end 231 of the shading cloth 23 opposite to the winding shaft 22 and disposed outwardly of the passageway 211. The shading unit 2 further includes a biasing member (not shown) having one end that is fixed, and the other end connected to the winding shaft 22 so as to bias the winding shaft 22 to rotate in a winding direction. Accordingly, when no external force is exerted on the winding shaft 22, the shading cloth 23 can be automatically wound around the winding shaft 22 and retracted into the housing 21. Since the structure of the shading unit 2 is well known in the art, it is not further detailed hereinafter.

The guide 3 extends in a top-bottom direction beneath the housing 21, and includes a guide rod case 31 that has a top end proximate to a bottom side of the housing 21, and a guide rod 32 inserted slidably into the guide rod case 31 and having a top end connected to the end strip 24. The guide rod case 31 includes a guide channel 311 extending in the top-bottom direction beneath the housing 21 for the guide rod 32 to slide therein, and two opposite apertures 312 formed in opposite sides of the wall of the guide rod case 31 and proximate to the top end of the guide rod case 31. The guide rod 32 includes a rod section 321 that is inserted into the guide channel 311 and that has a top end connected to the end strip 24, and a slide block 322 connected to the bottom end of the rod section 321 and disposed slidably in the guide channel 311. The slide block 322 has a pair of opposite notches 323 formed on two opposite sides thereof. The slide block 322 and the rod section 321 can be formed integrally as one piece, or by assembling separately fabricated pieces.

The semi-automatic sunshade device further includes a positioning mechanism 4 mounted between a top part of the guide rod case 31 and a bottom of the guide rod 32. The positioning mechanism 4 includes a seat 41 mounted on an upper portion of the guide rod case 31, a pair of pivot arms 42 fulcrumed to two opposite sides of the seat 41 by virtue of fulcrum pins 43, a pair of rollers 44 attached respectively to ends of the pivot arms 42, and a pair of springs 45 each mounted between the other end of a respective one of the pivot arms 42 and the seat 41. Each spring 45 urges the corresponding pivot arm 42 to pivot about the fulcrum pin 43 and to extend the roller 44 into the guide rod case 31 through the corresponding aperture 312.

The buffer 5 includes a buffer support 51 disposed fixedly between the housing 21 and the guide rod support 31, a hollow moving body 52 mounted movably to the buffer support 51 and surrounding the guide rod 32, a pair of buffer members 53 movably clamping the guide rod 32 and disposed inside the hollow moving body 52 in rolling contact with the guide rod 32, and a pair of springs 54 disposed between the buffer support 51 and the hollow moving body 52 to provide a biasing force to the hollow moving body 52. In this embodiment, the hollow moving body 52 is movable sideward and in a direction transverse to the guide rod 32. However, the direction of the movement of the hollow moving body 52 should not be limited only thereto and may be varied as desired.

The buffer support 51 includes a buffer case that has a receiving space 511, top and bottom openings 510 communicated with the receiving space 511, two opposite support plates 512 extending in a top-bottom direction and bounding the receiving space 511 on two opposite sides of the guide rod 32, and two opposite slide holes 5120 formed respectively in the support plates 512 and communicated with the receiving space 511. The guide rod 32 extends through the receiving space 511 and the top and bottom openings 510. The hollow moving body 52 has a looped wall 521 disposed within the receiving space 511 around the guide rod 32 and extending in a top-bottom direction, and two arms 522 projecting oppositely from two opposite sides of the looped wall 521, extending transversely of the guide rod 32, and respectively passing through the slide holes 512. While the buffer support 51 is in the form of the buffer case in this embodiment, the buffer support 51 should not be limited only thereto and may have any other configuration which is suitable to support the hollow moving body 52.

The buffer members 53 are mounted rotatably within the looped wall 521, and are disposed on two opposite sides of the guide rod 32 to movably clamp the guide rod 32 so as to hinder and slow down ascending and descending movements of the guide rod 32. In this embodiment, the buffer members 53 are configured as friction rollers that are made from a rubber material, such as silicone, rubber, etc., and that are rotatable about axes transverse to the guide rod 32. Of course, the rollers may also be made from other materials such as wood, metal, plastic, etc. Alternatively, the buffer members 53 may be formed as a pair of gears. The springs 54 are sleeved onto the respective arms 522 to provide a biasing force for the hollow moving body 52. However, the springs 54 are optional and may be dispensed with.

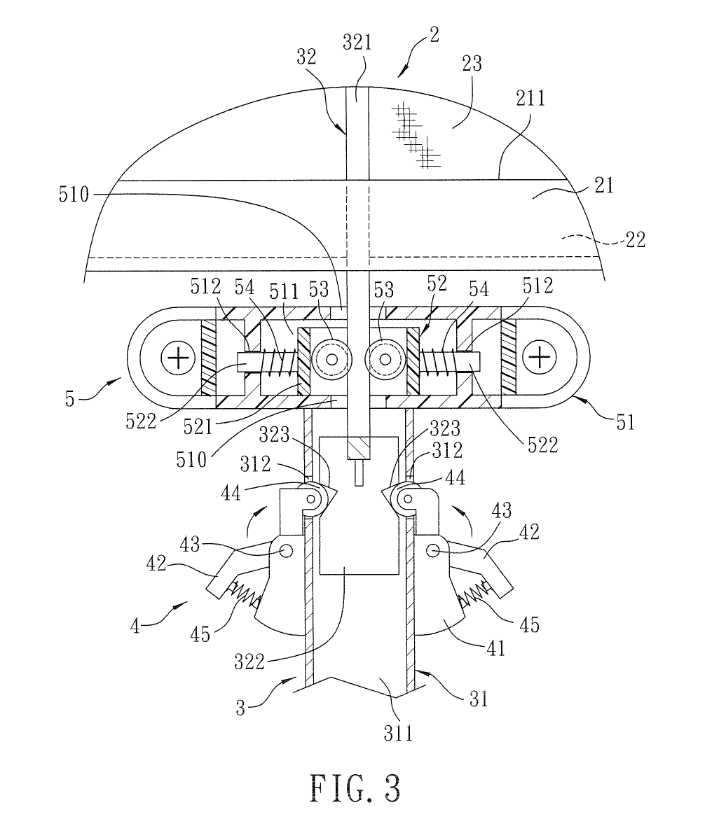

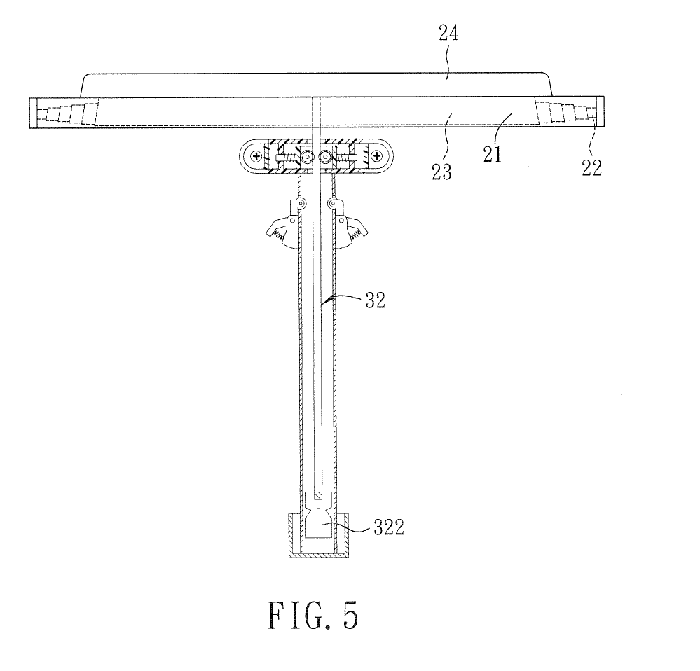

In use, the shading cloth 23 is movable between a stretched position as best shown in FIG. 2 and an un-stretched position as shown in FIG. 5. Referring back to FIGS. 2 and 3, when the shading cloth 23 is to be stretched, the end strip 24 is pulled to move upward the guide rod 32 until the slide block 322 at the bottom of the guide rod 32 moves to and pushes the rollers 44. Accordingly, the pivot arms 42 are turned outward against the biasing action of the springs 45. When the notches 323 of the slide block 322 reach the respective apertures 312, the springs 45 cause the pivot arms 42 to return to their original positions and the rollers 44 re-engage the respective notches 323. As a result, the shading cloth 23 is positioned firmly in its stretched position.

When the end strip 24 is pressed downward to un-stretch or fold the shading cloth 23, the guide rod 32 moves downward, and the slide block 322 disengages from the rollers 44, thereby permitting the winding shaft 22 to wind up the shading cloth 23. The guide rod 32 continues to move downward until the shading cloth 23 is completely retracted into the housing 21 by the winding shaft 22.

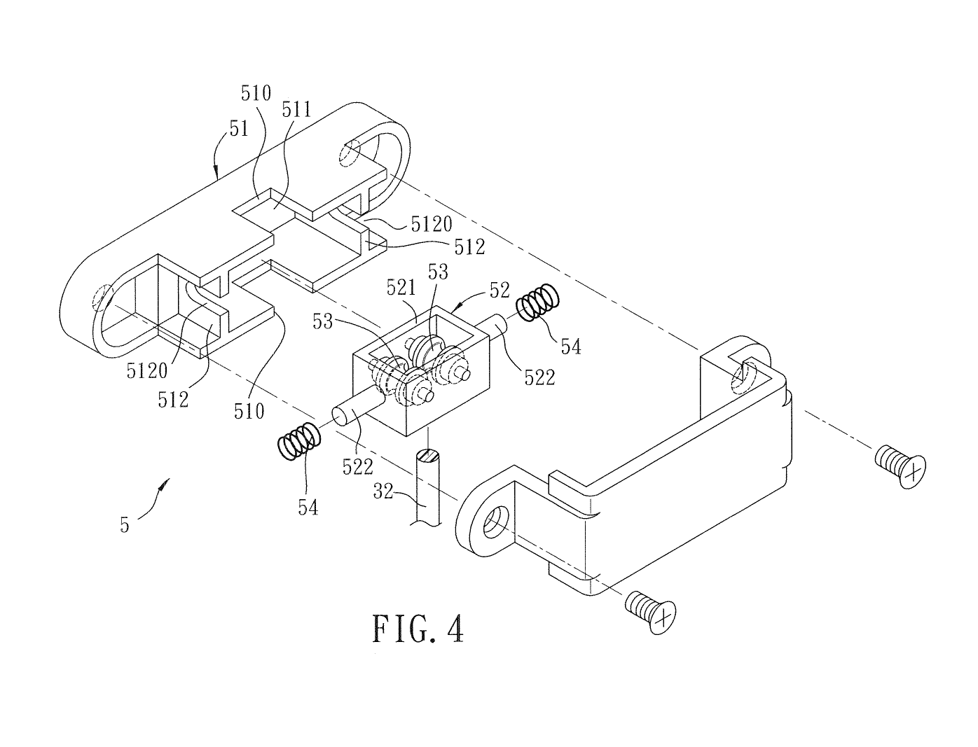

Referring once again to FIGS. 3 and 4, during the stretching and un-stretching operations of the shading cloth 23, the guide rod 32 is moved between the buffer members 53, which hinder ascending and descending movements of the guide rod 32. Accordingly, the moving speed of the shading cloth 23 and the end strip 24 is reduced, thereby preventing the guide rod 32 from vibration and the end strip 24 from impacting the housing 21.

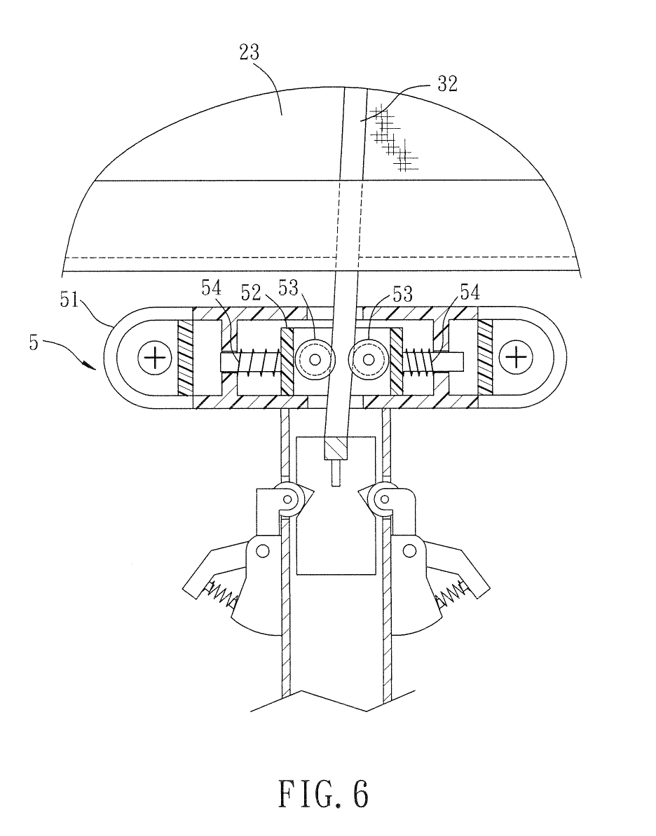

Referring to FIG. 6, in case the shading cloth 23 is configured to be stretched along an arcuate path, the moving direction of the guide rod 32 will deviate from a vertical direction. Since the hollow moving body 52 is mounted to the buffer case of the buffer support 51 in a resiliently movable fashion, the buffer members 53 are movable, and the guide rod 32 is allowed to displace or incline sideward resiliently. As such, impact forces on the side window may be avoided. Therefore, the guide 3 and the buffer 5 according to the present invention are suitable for use in combination with a shading cloth that is stretched curvedly.

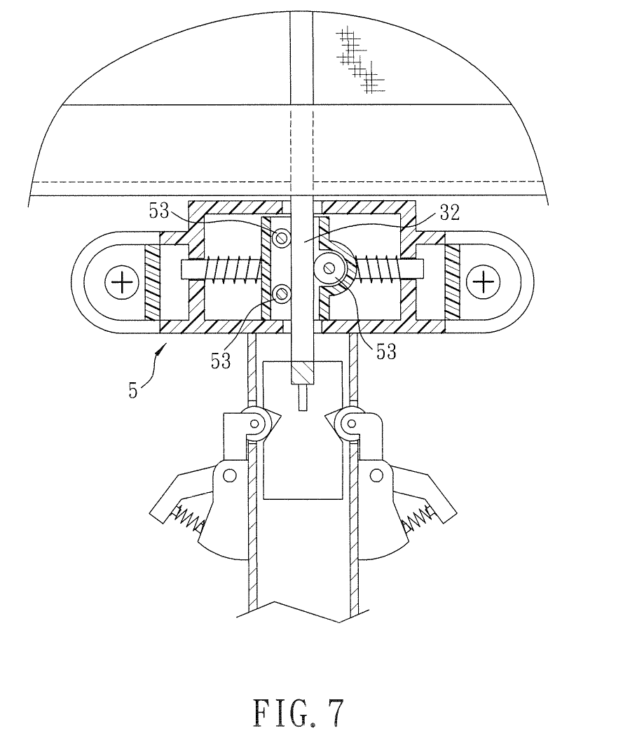

Referring to FIG. 7, the second preferred embodiment of this invention is generally identical to the first preferred embodiment. However, the second preferred embodiment includes three buffer members 53. Of course, the number of the buffer members 53 can be increased or decreased according to a real need. In this embodiment, the three buffer members 53 have rotation axes that are parallel to each other and that are disposed respectively on two sides of the guide rod 32. Two of the buffer members 53 are disposed on one side of the guide rod 32 and are alternate with the other buffer member 53 disposed on the other side of the guide rod 32.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A semi-automatic sunshade device, comprising:
a housing having a top side formed with a passageway;
a winding shaft mounted rotatably inside said housing;
a shading cloth wound around said winding shaft;
an end strip attached to one end of said shading cloth opposite to said winding shaft and disposed outwardly of said passageway;
a guide extending in a top-bottom direction beneath said housing, and including a guide rod case that has a top end proximate to a bottom side of said housing, and a guide rod inserted slidably into said guide rod case and having a top end connected to said end strip; and
a buffer including a buffer support disposed fixedly between said housing and said guide rod case, a hollow moving body mounted movably to said buffer support and surrounding said guide rod, and a plurality of buffer members movably clamping said guide rod and mounted inside said hollow moving body in rolling contact with said guide rod;
wherein said buffer members hinder ascending or descending movement of said guide rod when said end strip is operated to stretch or un-stretch said shading cloth and to move said guide rod.

2. The semi-automatic sunshade device of claim 1, wherein said buffer further includes at least one spring disposed between said buffer support and said hollow moving body to provide a biasing force to said hollow moving body.

3. The semi-automatic sunshade device of claim 2, wherein said buffer support includes a buffer case that has a receiving space, top and bottom openings communicated with said receiving space, and two opposite slide holes communicated with said receiving space, said guide rod passing through said receiving space and said top and bottom openings, said hollow moving body having a looped wall disposed within said receiving space and surrounding said guide rod, and two opposite arms projecting oppositely from said looped wall and respectively passing through said slide holes, said buffer members being mounted rotatably within said looped wall.

4. The semi-automatic sunshade device of claim 3, wherein said buffer includes two said springs each of which is disposed around one of said arms.

5. The semi-automatic sunshade device of claim 1, wherein said buffer includes two said buffer members having rotation axes that are transverse to said guide rod and that are disposed respectively on two sides of said guide rod.

6. The semi-automatic sunshade device of claim 1, wherein said buffer includes three said buffer members having rotation axes that are transverse to said guide rod and that are disposed on two sides of said guide rod, two of said buffer members being disposed on one side of said guide rod and being alternate with the other one of said buffer members disposed on the other side of said guide rod.

7. The semi-automatic sunshade device of claim 1, wherein said buffer members are configured as friction rollers.

8. The semi-automatic sunshade device of claim 1, wherein said hollow moving body is movable in a direction transverse to said guide rod.

9. The semi-automatic sunshade device of claim 8, wherein said hollow moving body has a looped wall extending in a top-bottom direction and surrounding said guide rod, and said buffer members are formed as rollers rotatable about axes transverse to said guide rod.

10. The semi-automatic sunshade device of claim 9, wherein said buffer support has two support plates bounding said receiving space and extending in a top-bottom direction on two opposite sides of said hollow moving body, and slide slots formed respectively in said support plates, said hollow moving body further having two arms projecting oppositely from said looped wall and extending transversely of said guide rod, said arms extending slidably and respectively through said slide slots.

11. The semi-automatic sunshade device of claim 10, wherein each of said arms is loaded with a spring.
